(19) United States
(12) Patent Application Publication
(10) Pub. No.: US 2010/0149658 A1
(43) Pub. Date: Jun. 17, 2010

(54) Lens module

(75) Inventors: Yun- Cheng Liu, Taipei County (TW); Bo-Yi Wu, Taipei County (TW); Ching-Yang Lin, Taichung City (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 12/385,694

(22) Filed: Apr. 16, 2009

(30) Foreign Application Priority Data
Dec. 16, 2008 (TW) 97222560

(51) Int. Cl. G02B 13/18

(52) U.S. Cl. 359/708

(57) ABSTRACT

A lens module is provided. The lens module comprises at least one square-shaped lens, a square-shaped filter, a circuit module and a plate base. The square-shaped lens comprises a light-transmitting part and two wings formed on two sides of the light-transmitting part. The circuit module comprises a light sensor. The first surface of the plate base comprises a plurality of slots, wherein the square-shaped lens, the square-shaped filter and the circuit module can be adapted to the slots respectively. A sidewall of the plate base further comprises an incident hole to make an incident light pass vertically through the square-shaped lens and the square-shaped filter and further sensed by the light sensor to generate an image signal to the circuit module.

### RELATED APPLICATIONS

This application claims priority to Taiwan Application Serial Number 97222560, filed Dec. 16, 2008, which is herein incorporated by reference.

### BACKGROUND

1. Field of Invention

The present invention relates to a lens module. More particularly, the present invention relates to a lens module comprising at least one square-shaped lens.

2. Description of Related Art

A common camera typically comprises circular lenses, and the lens holder comprises screw threads to hold the circular lenses in proper positions. However, a camera for taking line shaped photos comprises square-shaped lenses instead of the circular lenses. In such a case, the square-shaped lenses can't fit in the lens holder with the screw threads.

Accordingly, what is needed is a lens module to provide a fastening mechanism to fasten the square-shaped lenses in a camera for taking line shaped photos. The present invention addresses such a need.

### SUMMARY

A lens module is provided. The lens module comprises at least one square-shaped lens, a square-shaped filter, a circuit module and a plate base. The square-shaped lens comprises a light-transmitting part and two wings formed on two sides of the light-transmitting part. The circuit module comprises a light sensor. The first surface of the plate base comprises a plurality of slots, wherein the square-shaped lens, the square-shaped filter and the circuit module can be adapted to the slots respectively. A sidewall of the plate base further comprises an incident hole to make an incident light pass vertically through the square-shaped lens and the square-shaped filter and further sensed by the light sensor to generate an image signal to the circuit module.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is an exploded view of the lens module of the first embodiment of the present invention;

FIG. 2A is a front view of the square-shaped lens of the first embodiment of the present invention;

FIG. 2B is a top view of the square-shaped lens of the first embodiment of the present invention;

FIG. 2C is another top view of the square-shaped lens of an embodiment of the present invention;

FIG. 3A is perspective view of the slot and an arc plate of an embodiment of the present invention;

FIG. 3B is another perspective view of the slot and an arc plate of another embodiment of the present invention;

FIG. 3C is a bottom view of the slot and the square-shaped lens of yet another embodiment of the present invention; and

FIG. 4 is a perspective view of the lens module of an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

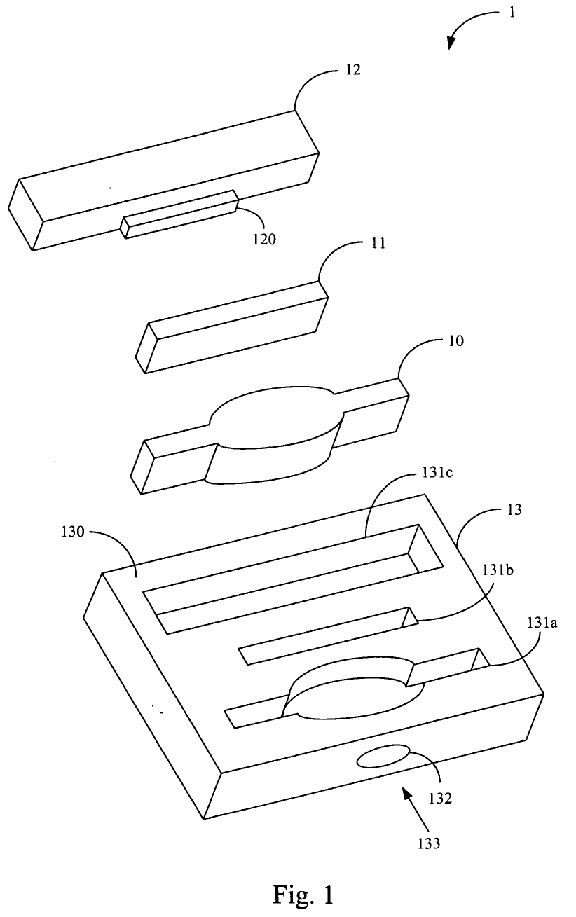

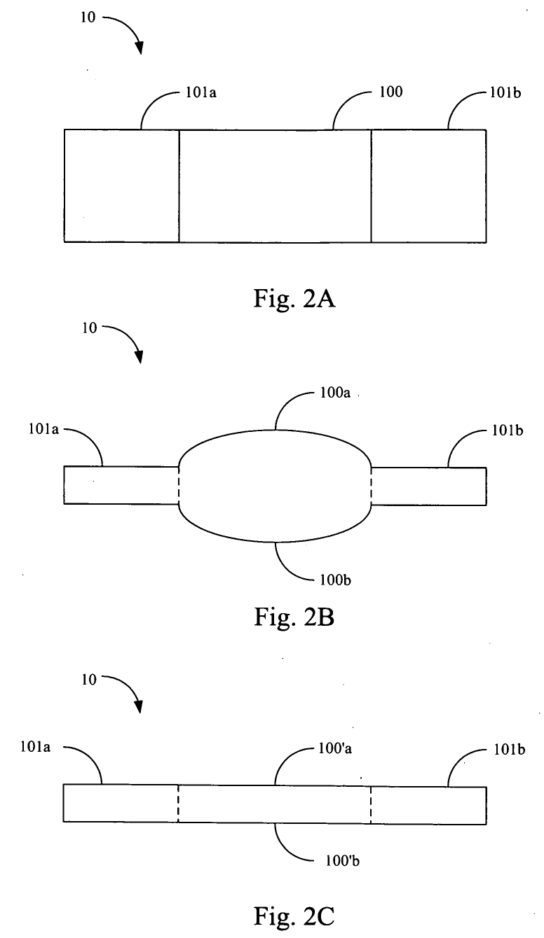

Please refer to FIG. 1. FIG. 1 is an exploded view of the lens module 1 of the first embodiment of the present invention. The lens module 1 comprises a square-shaped lens 10, a square-shaped filter 11, a circuit module 12 and a plate base 13. Please refer to FIG. 2A and FIG. 2B at the same time, wherein FIG. 2A is a front view of the square-shaped lens 10 and FIG. 2B is a top view of the square-shaped lens 10. As depicted in FIG. 2A, the lens 10 of the present invention is not a conventional circular shaped lens but a square-shaped lens, wherein the square-shaped lens 10 is to take line-shaped photos. The square-shaped lens 10 comprises a light-transmitting part 100 and two wings 101a and 101b formed on two sides of the light-transmitting part 100. In an embodiment, the light-transmitting part 100 has two light-transmitting surfaces that are two symmetrical spherical surfaces 100a and 100b as depicted in FIG. 2B. In another embodiment, the light-transmitting part 100 has two light-transmitting surfaces that are two flat surfaces 100a′ and 100b′ as depicted in FIG. 2C. The circuit module 12 comprises a light sensor 120. The first surface 130 of the plate base 13 comprises three parallel slots 131a, 131b and 131c, wherein the square-shaped lens 10, the square-shaped filter 11 and the circuit module 12 can be adapted to the slots 131a, 131b and 131c respectively. It's noticed that the number of the lenses in the lens module 1 can be different in other embodiments, while the number of the slots to contain the lenses will be different as well to match the number of the lenses. A sidewall of the plate base 13 further comprises an incident hole 132 to make an incident light 133 pass vertically through the square-shaped lens 10 and the square-shaped filter 11 and further sensed by the light sensor 120 to generate an image signal (not shown) to the circuit module 12.

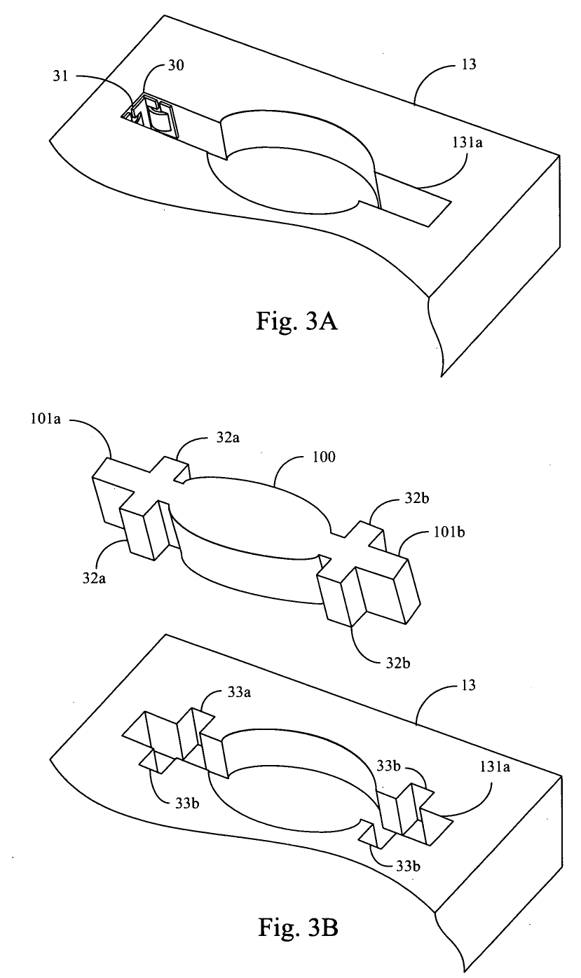

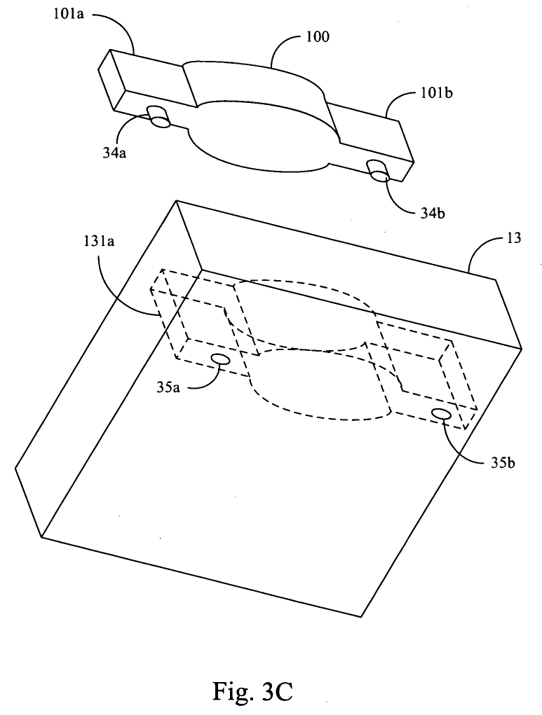

Please refer to FIG. 3A. FIG. 3A is perspective view of the slot 131a and an arc plate 31 of an embodiment of the present invention. The arc plate 31 is formed on a side 30 of the slot 131a to fasten the square-shaped lens 10. Besides the fastening mechanism, the arc plate 31 can further control the incident angle of the incident light 133 to adjust the position of the image by changing the radian of the arc plate 31. Similarly, the arc plate 31 can be applied to the slot 131c corresponding to the circuit module 12. FIG. 3B is another perspective view of the slot 131a and the square-shaped lens 10 of another embodiment of the present invention. In the present embodiment, two stripe-like bulges 32a and 32b are formed on the two wings 101a and 101b of the square-shaped lens 10 respectively. Two chamfers 33a and 33b are formed on the sidewall of the slot 131a to make the two bulges 32a and 32b lodge in the chamfers 33a and 33b respectively. FIG. 3C is a bottom view of the slot 131a and the square-shaped lens 10 of yet another embodiment of the present invention. In the present embodiment, two small bulges 34a and 34b are formed on the bottom of the two wings 101a and 101b of the square-shaped lens 10 respectively. Two holes 35a and 35b are formed on the bottom of the slot 131a to make the two bulges 34a and 34b lodge in the holes 35a and 35b respectively. Both the two embodiments shown above provide greater fastening mechanism to prevent the square-shaped lens 10 from displacing.

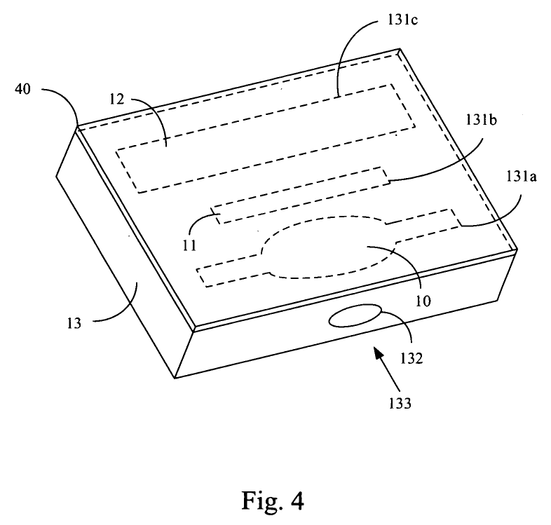

Please refer to FIG. 4. FIG. 4 is a perspective view of the lens module 1 of an embodiment of the present invention. The square-shaped lens 10, the square-shaped filter 11 and the circuit module 12 are placed in the slots 131a, 131b and 131c of the plate base 13 respectively. The lens module 1 of the present embodiment further comprises a cover plate 40 to cover the top of the plate base 13 to cover the square-shaped lens 10, the square-shaped filter 11 and the circuit module 12. The cover plate 40 not only prevents the square-shaped lens 10, the square-shaped filter 11 and the circuit module 12 from displacing but also prevents the loss of the incident light.

The advantage of the present invention is to make the square-shaped lens, the square-shaped filter and the circuit module embed in the slots and further provide greater fastening mechanism through the design of the arc plate, the bulges and the cover plate.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A lens module comprising:
at least one square-shaped lens comprising a light-transmitting part and two wings formed on two sides of the light-transmitting part;
a square-shaped filter;
a circuit module comprising a light sensor; and
a plate base, wherein the first surface of the plate base comprises a plurality of slots, wherein the square-shaped lens, the square-shaped filter and the circuit module can be adapted to the slots respectively, a sidewall of the plate base further comprises an incident hole to make an incident light pass vertically through the square-shaped lens and the square-shaped filter and further sensed by the light sensor to generate an image signal to the circuit module.

2. The lens module of claim 1, wherein at least one arc plate is formed on a side of the slots of the plate base to fasten at least one square-shaped lens.

3. The lens module of claim 1, wherein at least one arc plate is formed on a side of the slots of the plate base to fasten the circuit module.

4. The lens module of claim 1, wherein the light-transmitting part has two light-transmitting surfaces that are two symmetrical spherical surfaces.

5. The lens module of claim 1, wherein the light-transmitting part has two light-transmitting surfaces that are two flat surfaces.

6. The lens module of claim 1, wherein at least one chamfer is formed on the side wall of the slot and at least one bulge is formed on each of the two wings of the square-shaped lens to lodge in the at least one chamfer.

7. The lens module of claim 1, wherein at least one hole is formed on the bottom of the slot and at least one bulge is formed on each of the two wings of the square-shaped lens to lodge in the at least one hole.

8. The lens module of claim 1, further comprising a cover plate to cover the top of the plate base to cover the at least one square-shaped lens, square-shaped filter and the circuit module adapted in the plate base.
